(19) United States
(12) Patent Application Publication
(10) Pub. No.: US 2015/0020912 A1
(43) Pub. Date: Jan. 22, 2015

(54) DUCT

(71) Applicant: SF Ltd, Devon (GB)

(72) Inventor: Sami O. CAGLAR, Devon (GB)

(73) Assignee: SF Ltd, Devon (GB)

(21) Appl. No.: 13/962,165

(22) Filed: Aug. 8, 2013

(30) Foreign Application Priority Data
Jul. 19, 2013 (GB) 1312968.9

(51) Int. Cl. F16L 11/14; F16L 55/00

(52) U.S. Cl. CPC F16L 11/14; F16L 55/00
USPC 138/120; 29/428

(57) ABSTRACT

There is disclosed a duct 10 for hot gases, such as a chimney, comprising first and second duct sections 20 each having a generally radially extending mating flange 30, 32. The duct sections 20 are disposed end-to-end such that the mating flanges 30, 32 cooperate with one another to form a joint. The duct also comprises a substantially annular sealing band 44 having a radially extending expansion channel 46 at least partly defined by first and second radially extending channel walls 52, 54. The sealing band 44 is disposed around the joint with the mating flanges 30, 32 disposed within the expansion channel 46. The mating flanges 30, 32 can move within the expansion channel 46 to accommodate dimensional changes of the duct 10 that may occur due to thermal effects.

### CROSS-REFERENCE TO RELATED APPLICATION

This application claims priority under 35 U.S.C. §119 to British Patent Application No. 1312968.9 filed Jul. 19, 2013. British Patent Application No. 1312968.9 is incorporated herein by reference in its entirety for all purposes.

The invention relates to a duct comprising first and second duct sections disposed end-to-end. The invention is particularly, although not exclusively, concerned with such a duct in the form of a chimney or exhaust to convey the products of combustion to atmosphere, such as a twin-walled or single-walled chimney.

It is known to assemble ducts for hot gasses, such as chimneys, from prefabricated duct sections which are interconnected end-to-end. In one known arrangement each duct section is provided with a flange and a gasket is disposed between the opposing flanges of adjacent duct sections. In order to secure and seal the duct sections together, a sealing band is tightened around the joint between the adjacent duct sections. The sealing band is provided with a V-shaped channel within which the flanges are located. As the band is tightened, the inclined walls that define the V-shaped channel act on the flanges to axially urge them towards one another, thereby compressing the gasket disposed between the flanges and forming a tight seal.

Whilst this arrangement may be satisfactory, during use, hot exhaust gasses passed through the chimney may cause the duct sections to thermally expand, particularly in the radial direction. The radial thermal expansion causes the outer diameter of the flanges to increase and the flanges act on the inclined walls of the V-shaped channel to deform and “open” the channel (i.e. the internal angle is increased) with potential further damage to the flanges and/or gasket. As the chimney cools down, the duct sections contract, but the sealing band remains deformed. This loosens the joint between the two duct sections and compromises the performance of the joint between the duct sections. Repeated thermal expansion and contraction causes further loosening of the joint, further compromising the seal performance and the integrity of the joint.

It is therefore desirable to provide an improved duct which can better accommodate thermal expansion and contraction.

According to an aspect of the invention there is provided a duct for hot gases, comprising: first and second duct sections each having a generally radially extending mating flange, wherein the duct sections are disposed end-to-end such that the mating flanges cooperate with one another to form a joint; and a substantially annular sealing band having a radially extending expansion channel at least partly defined by first and second radially extending channel walls, the sealing band being disposed around the joint with the mating flanges disposed within the expansion channel; wherein the mating flanges can move within the expansion channel to accommodate dimensional changes of the duct that may occur due to thermal effects. The joint may be a sealed joint. The dimensional changes may be thermal expansion and/or contraction of the duct sections. The mating flanges may be able to move within the expansion channel without deforming the expansion channel and/or sealing band and/or flanges and/or gasket (where present). The expansion channel may be configured, such as being dimensioned, to allow the mating flanges to move within the expansion channel.

The duct may be an exhaust duct. The duct sections may be substantially identical. The duct sections may be axially extending. Each duct section may comprise a mating section at opposing ends, the mating section including the radially extending mating flange. The mating section of the first duct section may cooperate with the mating section of the second duct section. The duct sections may be double-walled or single-walled.

The outer diameter of expansion channel may be greater than the outer diameter, or maximum outer diameter, of the mating flanges. The inner diameter of the expansion channel may be less than the outer diameter, or minimum outer diameter, of the mating flanges. The or each mating flange may be annular. The expansion channel may be annular. The expansion channel may be open at its radially inner end. The radial length of the expansion channel may be greater than the radial length of the mating flanges. The abovementioned conditions may be satisfied at ambient conditions and may be satisfied across the working temperature range of the duct which may be between 500° C. and 1300° C., or between 600° C. and 1200° C., or between 700° C. and 1100° C., for example. In some arrangements the temperature may be continuously above 700° C., and may intermittently reach temperatures as high as 1100° C.

The sealing band may comprise first and second side walls that extend away from the first and second channel walls respectively in directions that are oblique to the channel walls. The first and second side walls may extend in the axial direction. The first and second side walls may be radially spaced from side walls of the duct sections. The innermost diameters of the side walls may be greater than the outer diameter of side walls of the duct sections.

The sealing band may be moveable in a transverse plane (i.e. a plane perpendicular to the axis) with respect to the duct sections. This may be referred to as “floating” since the sealing band is not fixed.

The expansion channel may be at least partly further defined by a channel end wall that spaces and connects the channel walls. The channel end wall may define the outer diameter of the expansion channel. The channel walls may be substantially parallel to one another.

The expansion channel may axially urge the mating flanges towards one another. The duct may further comprise a resiliently deformable gasket disposed between the mating flanges. The height of the expansion channel may be less than the combined height of the mating flanges and the non-deformed gasket. The force required to deform the gasket may be less than the force required to deform, or open, the expansion channel.

The sealing band may comprise at least one fastener for securing the sealing band around the joint. The fastener may comprise one or more brackets, bolts, hinges, screws, or other mechanical fasteners.

The sealing band may comprise at least two circumferentially extending parts that are secured together around the joint to form an annulus, and which can be moved apart such that during assembly the sealing band can be located around the joint. The sealing band may comprise at least two completely separable circumferentially extending parts. The sealing band may comprise two circumferentially extending halves which can be moved apart. The two halves may be completely separable.

The expansion channel may have a U-shaped or rectangular cross-section in an axial plane (i.e a plane containing the axis).

The duct may further comprise a substantially annular securing band located around the duct sections so as to secure the duct sections together. The securing band may be located radially outside the sealing band. Insulation material may be disposed inside the securing band and around the joint.

The duct sections and sealing band may be made from a metal, which may be stainless steel, such as austenitic stainless steel. It should be appreciated that other materials may be appropriate.

The duct may be a chimney, such as a twin-walled chimney, which may comprise not only the first and second duct components but also further duct components and/or ancillary components such as tee fittings, elbows and support and attachment components.

The invention also relates to a sealing band for use with a duct in accordance with any statement herein.

According to another aspect of the invention there is provided a kit of parts for forming the duct in accordance with any statement herein, the kit of parts comprising first and second duct sections each having a generally radially extending mating flange; and a substantially annular sealing band having a radially extending expansion channel at least partly defined by first and second radially extending channel walls.

According to a further aspect of the invention there is provided a method of manufacturing a duct in accordance with any statement herein, the method comprising:

disposing first and second duct sections each having a generally radially extending mating flange end-to-end such that the mating flanges cooperate with one another to form a joint; and disposing a substantially annular sealing band having a radially extending expansion channel at least partly defined by first and second radially extending channel walls around the joint with the mating flanges disposed within the expansion channel.

The invention may comprise any combination of the features and/or limitations referred to herein, except combinations of such features as are mutually exclusive.

Embodiments of the invention will now be described, by way of example, with reference to the accompanying drawings, in which:

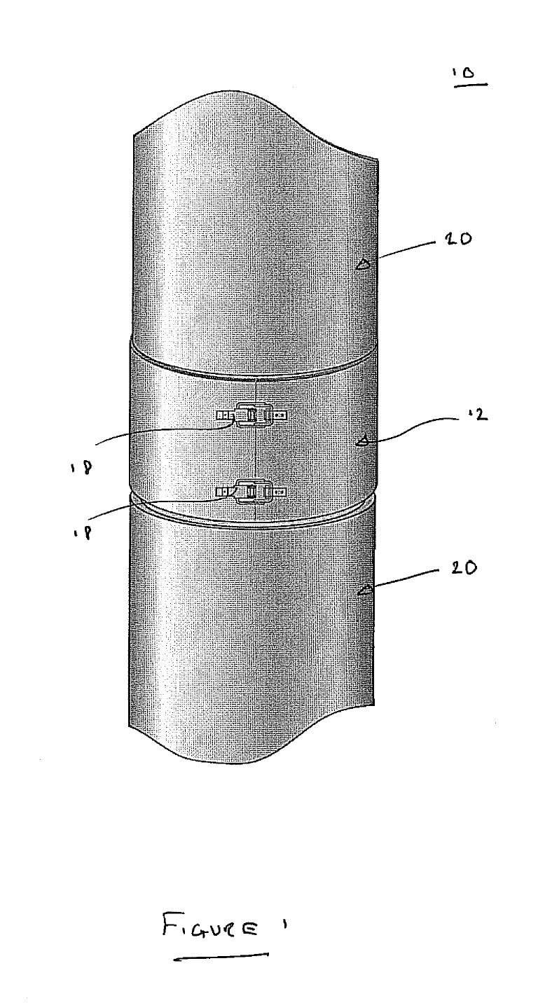

FIG. 1 schematically shows a perspective view of an assembled chimney;

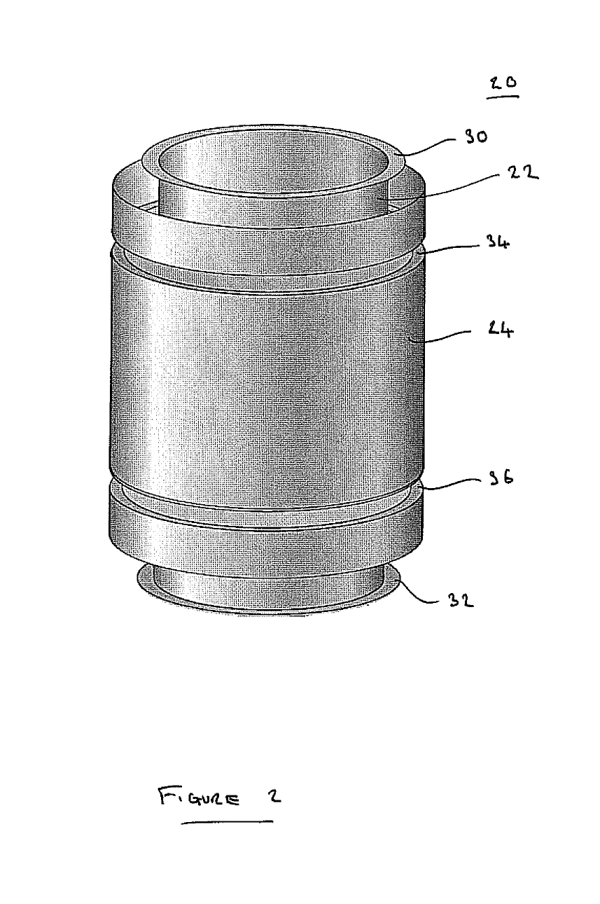

FIG. 2 schematically shows a perspective view of a duct section;

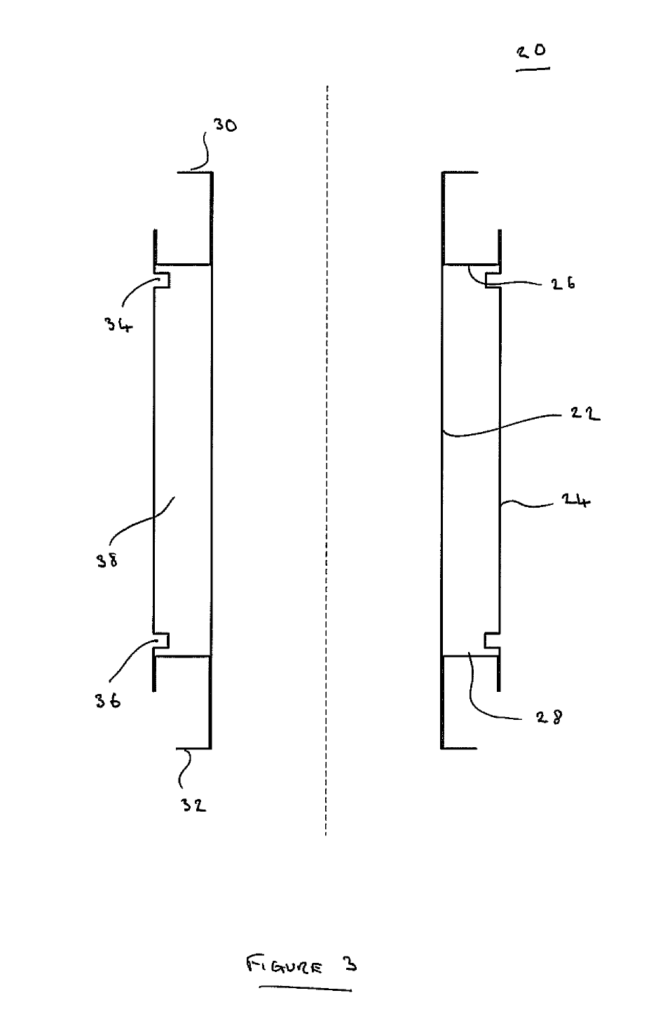

FIG. 3 schematically shows a cross-sectional view of a duct section;

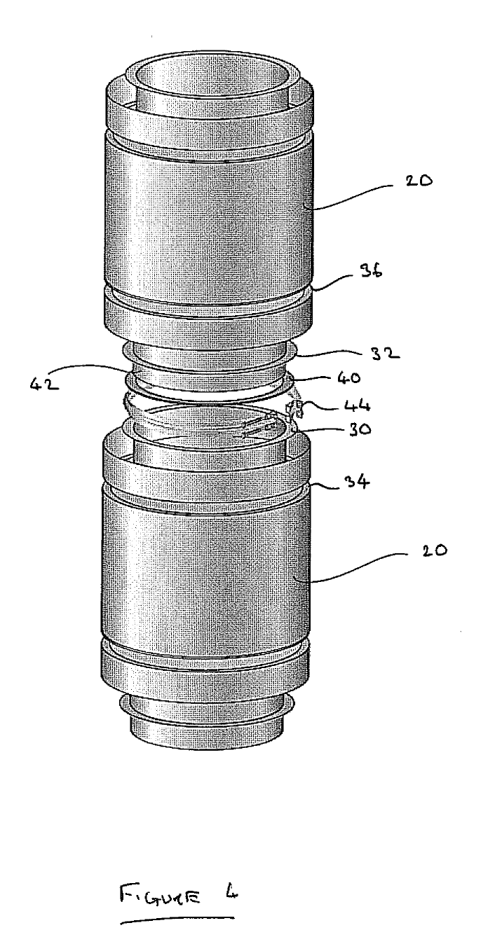

FIG. 4 schematically shows an exploded view of two duct sections to be assembled;

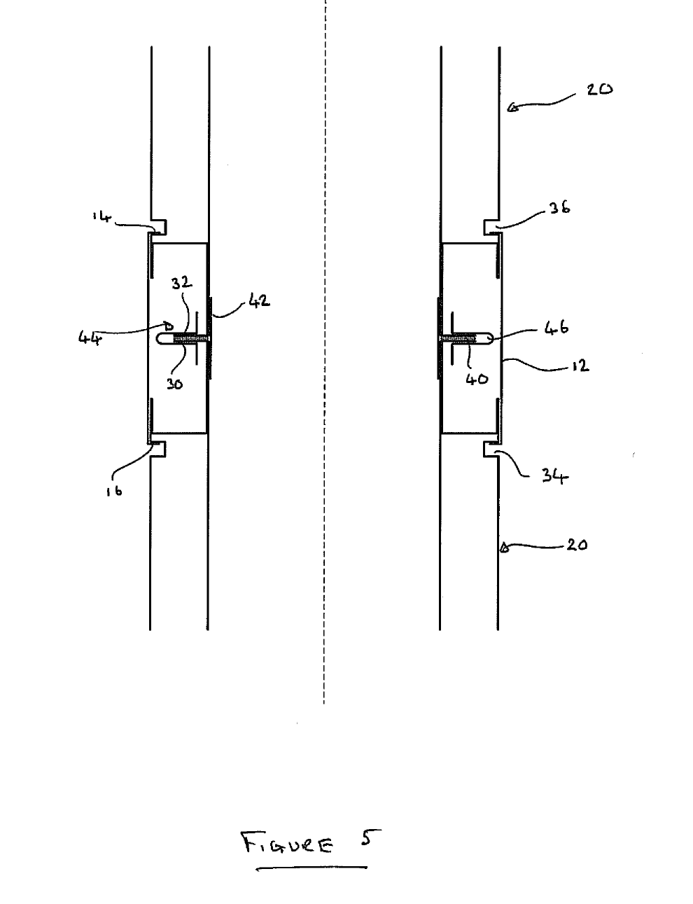

FIG. 5 schematically shows a cross-sectional view of the join between two assembled duct sections;

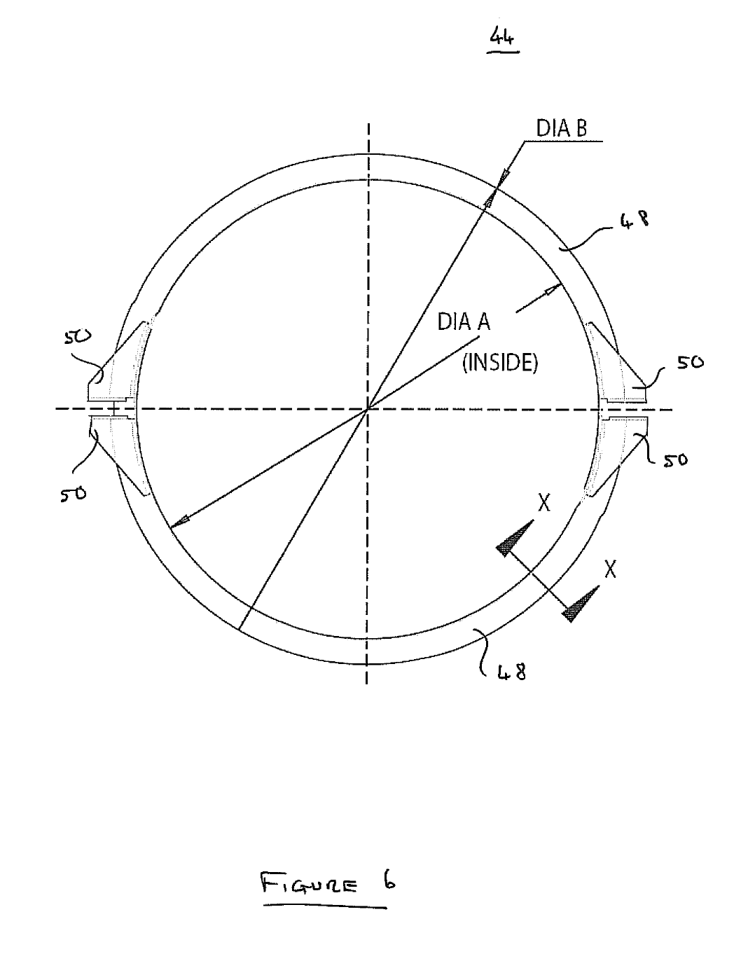

FIG. 6 schematically shows a plan view of a sealing band;

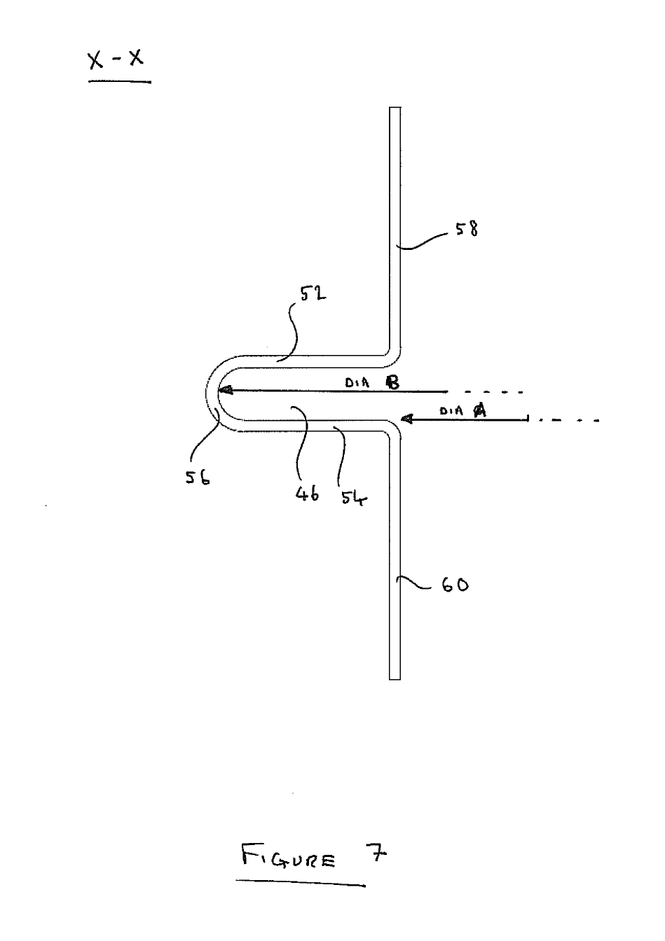

FIG. 7 schematically shows the cross-sectional view along the line X-X of FIG. 6; and

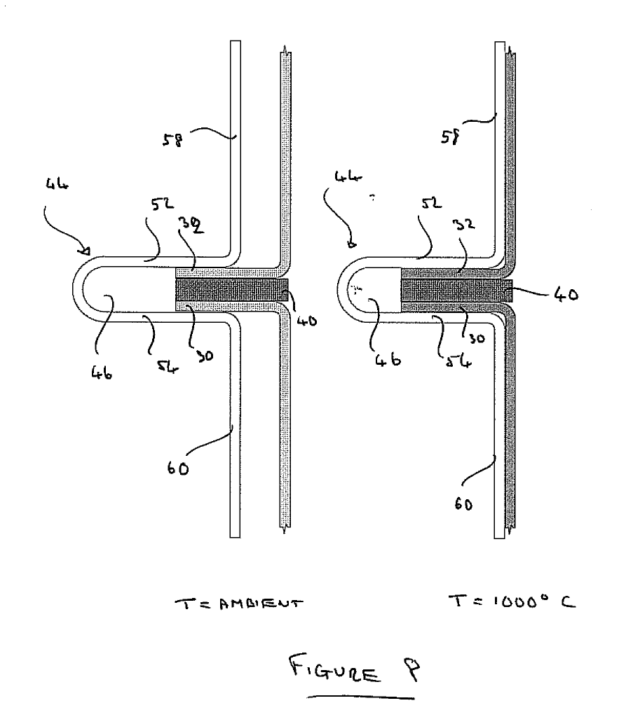

FIG. 8 schematically shows the sealing band around a joint at both ambient and high-temperature conditions.

FIG. 1 shows part of a duct for hot gasses, in the form of a chimney 10, comprising two axially extending duct sections 20 disposed end-to-end. As will be described in detail below, in this embodiment the duct sections 20 are substantially identical and are joined together to form a seal between them. The chimney also comprises an annular securing band 12 which is disposed around the duct sections 20 and overlaps them so as to secure the duct sections 20 together. Although it will be described that the chimney 10 comprises two duct sections 20, it should be appreciated that any suitable number of duct sections 20 may be joined together to form a chimney 10 of a desired length.

With reference to FIGS. 2 and 3, the duct section 20 is substantially cylindrical and extends in the general axial direction. The duct section 20 is cylindrically symmetric and is also symmetric about a transverse plane (i.e. a plane perpendicular to the axis). The duct section 20 comprises a cylindrical inner wall 22 and a generally cylindrical outer wall 24 having a diameter that is larger than that of the inner wall 22. The duct section 20 also comprises upper and lower annular spacers 26, 28 that connect and space the inner wall and the outer wall 22, 24. The upper spacer 26 is disposed towards the upper end of the duct section 20 and the lower spacer 28 is disposed towards the lower end of the duct section 20. The upper end of the inner wall 22 is provided with an annular mating flange 30 that outwardly extends in the radial direction, and the lower end of the inner wall 22 is provided with a similar annular mating flange 32 that also outwardly extends in the radial direction. An upper annular groove 34 is provided in the outer wall 24 towards the upper end and a lower annular groove 36 is provided in the outer wall 24 towards the lower end. The space 38 between the inner and outer walls 22, 24 can be loose filled or wrapped to provide thermal insulation with an insulating material such as, but not restricted to, mineral wool or ceramic fibre.

As shown in FIGS. 4 and 5, to assemble a chimney, two substantially identical duct sections 20 are disposed end-to-end with an annular gasket 40 disposed between the opposing mating flanges 30, 32. A tubular liner 42 can be inserted within the inner walls 22 such that it overlaps the joint between the two duct sections 20. The tubular liner 42 is held in position by resistance welding. In order to seal the joint between the opposing mating flanges 30, 32 a two-part annular sealing band 44 is located around the joint. As will be described in detail below, the sealing band 44 has a U-shaped expansion channel 46 within which the mating flanges 30, 32 and the gasket 40 are disposed. The sealing band 44 axially urges the mating flanges 30, 32 together so as to compress the gasket 40, thereby forming a seal. An insulating material (not shown) is then placed around the joint, and an annular securing band 12 is located around the duct sections 20 to secure them relative to one another. The securing band 12 has upper and lower radially inwardly projecting flanges 14, 16 that locate within the upper groove 34 of one duct section 20, and the lower groove 36 of the other duct section 20. The securing band 12 is secured around the duct sections 20 by two over-centre latches 18 (FIG. 1).

During use, hot gasses pass through the chimney 10 and therefore the chimney 10 may reach temperatures of up to 1100° C., for example. The increase in temperature of the chimney 10 causes the duct sections 20 to expand, and as the chimney 10 cools again the duct sections 20 contract. This results in the outer diameter of the mating flanges 30, 32 varying between a minimum diameter DIA MIN and a maximum diameter DIA MAX. As will be described in detail below, the sealing band 44 is configured to accommodate these dimensional changes without being deformed. This results in an improved seal between the duct sections.

FIGS. 6 and 7 show the sealing band 44 in more detail. As shown in FIG. 6, the annular sealing band 44 is formed from two substantially identical half-bands 48 that circumferentially extend over 180°. Each end of the half-band 48 is provided with a bracket 50 such that the half-bands 48 can be attached together using fixings, such as nuts and bolts, to form a complete annulus. With the exception of the brackets 50, the cross-sectional profile of the sealing band 44 is substantially constant. As shown in FIG. 7, the sealing band 44 comprises an annular expansion channel 46 that extends in the radial direction. The expansion channel 46 is open at its radially inner end such that it can receive the mating flanges 30, 32 and the gasket 40. The expansion channel 46 is defined by upper and lower radially extending and parallel channel walls 52, 54, and a channel end wall 56 that separates and joins the channel walls 52, 54 at their radially outer ends. The sealing band 44 also comprises upper and lower side walls 58, 60 that axially extend from the radially inner ends of the upper and lower channel walls 52, 54 in opposing directions.

The outer diameter DIA B of the expansion channel 46 is set such that it is greater than the maximum diameter DIA MAX of the mating flanges 30, 32 and the inner diameter DIA A of the expansion channel 46 is set such that it is less than the minimum diameter DIA MIN of the mating flanges 30, 32. As will be described in detail below, this allows the mating flanges 30, 32 to move within the expansion channel 46 without abutting the end of the channel 46.

During assembly, the two half-bands 48 of the sealing band 48 are located around the joint and the two mating flanges 30, 32 and the gasket 40 are located within the expansion channel 46. The brackets 50 are fastened together so as to fix the two half-bands 48 together. The height of the expansion channel 46 is less than the combined height of the mating flanges 30, 32 and the gasket 40 in its resting (non-deformed) state. Therefore, with the mating flanges 30, 32 located in the expansion channel 46 they are axially forced together to compress the gasket 40, thereby forming a seal between the duct sections 20. The force required to deform the gasket 40 is less than the force required to “open” or deform the expansion channel 46. This prevents the shape of the expansion channel 46 from being deformed. The assembled sealing band 44 “floats” since it is able to move somewhat in a transverse plane. Unlike prior art sealing bands, the floating sealing band 44 it is not tightened around the joint and the side walls 58, 60 are radially spaced from the side walls of the duct sections 20, at least at ambient conditions.

Referring now to FIG. 8, at ambient conditions the radially outer ends of the mating flanges 30, 32 are located within the radially inner end of the expansion channel 46. As the temperature of the duct sections 20 increases, the duct sections 20 expand in the radial direction and therefore the outer diameter of the mating flanges 30, 32 increases. This radial thermal expansion causes the mating flanges 30, 32 to move within the expansion channel 46 to accommodate for this thermal expansion. Advantageously, this allows the duct sections 20 to thermally expand without damaging or deforming the sealing band 44 or the mating flanges 30, 32 or the gasket 40. Specifically, since the expansion channel 46 is radially extending and is defined by parallel and radially extending channel walls 52, 54, movement of the mating flanges 30, 32 within the expansion channel 46 does not open or deform the shape of the expansion channel 46. Therefore, when the duct sections 20 contract, the mating flanges 30, 32 contract radially inwardly and return to their original position. Since the shape of the expansion channel 46 is not deformed or altered, the channel walls 52, 54 still axially urge the mating flanges 30, 32 towards one another with the same (or at least largely similar) force, thereby maintaining a good seal. This is a significant improvement over prior art arrangements.

Although it has been described that the expansion channel 46 has a U-shaped profile, it should be appreciated that other cross-sections may be suitable. For example, the expansion channel 46 may have a rectangular profile. It is important that the expansion channel 46 is radially extending and is defined by radially extending channel walls. In the above embodiment it has been described that the sealing band 44 is provided as two completely separable half-bands. This enables it to be assembled around the joint. However, it should be appreciated that in other embodiments the half-bands may be hinged, the band may be a single piece, or may be made from any number of suitable pieces, with or without an overlap, to form a complete annulus.

1. A duct for hot gases, comprising:
first and second duct sections each having a generally radially extending mating flange, wherein the duct sections are disposed end-to-end such that the mating flanges cooperate with one another to form a joint; and
a substantially annular sealing band having a radially extending expansion channel at least partly defined by first and second radially extending channel walls, the sealing band being disposed around the joint with the mating flanges disposed within the expansion channel;
wherein the mating flanges can move within the expansion channel to accommodate dimensional changes of the duct that may occur due to thermal effects.

2. A duct according to claim 1, wherein the outer diameter of expansion channel is greater than the outer diameter of the mating flanges.

3. A duct according to claim 1, wherein the inner diameter of the expansion channel is less than the outer diameter of the mating flanges.

4. A duct according to claim 1, wherein the sealing band comprises first and second side walls that extend away from the first and second channel walls respectively in directions that are oblique to the channel walls.

5. A duct according to claim 4, wherein the first and second side walls are radially spaced from side walls of the duct sections.

6. A duct according to claim 1, wherein the sealing band is moveable in a transverse plane with respect to the duct sections.

7. A duct according to claim 1, wherein the expansion channel is at least partly further defined by a channel end wall that spaces and connects the channel walls.

8. A duct according to claim 1, wherein the channel walls are substantially parallel to one another.

9. A duct according to claim 1, wherein the expansion channel axially urges the mating flanges towards one another.

10. A duct according to claim 1, wherein the sealing band comprises at least one fastener for securing the sealing band around the joint.

11. A duct according to claim 1, wherein the sealing band comprises at least two circumferentially extending parts that are secured together around the joint to form an annulus, and which can be moved apart such that during assembly the sealing band can be located around the joint.

12. A duct according to claim 11, wherein the sealing band comprises at least two completely separable circumferentially extending parts.

13. A duct according to claim 1, further comprising a gasket disposed between the mating flanges.

14. A duct according to claim 1, wherein the expansion channel has a U-shaped or rectangular cross-section in an axial plane.

15. A duct according to claim 1, further comprising a substantially annular securing band located around the duct sections so as to secure the duct sections together.

16. A sealing band for use with a duct in accordance to claim 1.

17. A kit of parts for forming the duct in accordance with claim 1, the kit of parts comprising:
first and second duct sections each having a generally radially extending mating flange; and
a substantially annular sealing band having a radially extending expansion channel at least partly defined by first and second radially extending channel walls.

18. A duct, sealing band or kit of parts substantially as described herein with reference to the accompanying drawings.

19. A method of manufacturing a duct in accordance with claim 1, the method comprising:
disposing first and second duct sections each having a generally radially extending mating flange end-to-end such that the mating flanges cooperate with one another to form a joint; and
disposing a substantially annular sealing band having a radially extending expansion channel at least partly defined by first and second radially extending channel walls around the joint with the mating flanges disposed within the expansion channel.

20. A method according to claim 19 and substantially as described herein.
